(19) United States
(12) Patent Application Publication
(10) Pub. No.: US 2012/0099232 A1
(43) Pub. Date: Apr. 26, 2012

(54) SEMICONDUCTOR INTEGRATED CIRCUIT

(76) Inventors: Masaki Kuroyabu, Tokyo (JP); Yoshihiro Takahashi, Tokyo (JP)

(21) Appl. No.: 13/380,097

(22) PCT Filed: Jun. 3, 2010
(86) PCT No.: PCT/JP2010/059469

§ 371 Date: Dec. 22, 2011

(30) Foreign Application Priority Data
Jul. 2, 2009 (JP) 2009-158080

(51) Int. Cl. H02H 9/00

(52) U.S. Cl. 361/56

(57) ABSTRACT

A DC/DC-converter semiconductor integrated circuit using a bootstrap circuit includes a protection device having a standard breakdown voltage to break down between a first terminal and a second terminal, between which a capacitor of the bootstrap circuit is located, in response to a voltage higher than a maximum voltage applied to the capacitor.

### TECHNICAL FIELD

The disclosures herein relate to a DC/DC-converter semiconductor integrated circuit using a bootstrap circuit.

### BACKGROUND ART

DC/DC-converter semiconductor integrated circuits using a bootstrap circuit have conventionally been used in various applications (see Patent Document 1, for example).

FIG. 4 is a block diagram showing an example of a related-art DC/DC-converter semiconductor integrated circuit. In FIG. 4, a capacitor C1 is located between an external terminal BS and an external terminal SW of a semiconductor integrated circuit 10, and a Schottky diode SD is located between the external terminal SW and an external terminal GND. The external terminal SW is connected to an output terminal 11 through an inductor L1. Series-connected resistors R1 and R2 are located between the output terminal 11 and the external terminal GND. A capacitor C2 also connects therebetween. The connection point between the resistors R1 and R2 is connected to an external terminal FB of the semiconductor integrated circuit 10. A direct-current voltage of 12 V, for example, is applied from an external source to an external terminal VIN of the semiconductor integrated circuit 10.

In the semiconductor integrated circuit 10, a regulator 12 generates a direct-current voltage of 5 V, for example, from the direct-current voltage (e.g., 12 V) supplied through the external terminal VIN for provision to each part of the semiconductor integrated circuit 10, and, also, applies the above-noted 5-V direct-current voltage to the external terminal BS through a diode D1.

The external terminal SW is connected to the source of an n-channel MOS transistor M1 and the drain of an n-channel MOS transistor M2 serving as switching devices. The MOS transistor M1 has a drain thereof connected to the external terminal VIN, and a gate thereof to which a switching signal output from a driver circuit 13 is applied. The driver circuit 13 receives an operating power from the external terminals BS and SW. The MOS transistor M2 has a source thereof connected to the external terminal GND, and a gate thereof to which a switching signal output from a driver circuit 14 is applied.

A switch control unit 15 supplies switching signals having polarities opposite to each other to the driver circuits 13 and 14, respectively, thereby turning on the MOS transistors M1 and M2 alternately. The external terminal SW is set in the ground level when the MOS transistor M1 is in the off state (i.e., M2 in the on state), so that the capacitor C1 is charged with the 5-V voltage, resulting in the external terminal BS being set to 5 V.

The external terminal SW is set to 12 V supplied from the external terminal VIN when the MOS transistor M1 is in the on state (i.e., M2 in the off state), so that the external terminal BS is set to 17 V due to the charged voltage of the capacitor C1. This switching is repeatedly performed to output a predetermined direct-current voltage from the terminal 11 through smoothing by the inductor L1 or the like. In such a configuration in which the voltage at the external terminal SW is switched between HIGH and LOW by the switching devices M1 and M2, the capacitor C1 is provided between the external terminal SW and the external terminal BS. The charged voltage of this capacitor is used to apply a voltage higher than the voltage of the external terminal VIN to the external terminal BS, thereby supplying this higher voltage to the driver circuit 13 of the HIGH-side switching device M1 as a drive voltage. This makes it possible to fully turn on the HIGH-side switching device M1. The circuit to provide this high drive voltage is a bootstrap circuit.

The output voltage of the output terminal 11 is divided by the resistors R1 and R2 for provision to the inverted-input terminal of an error amplifier 16 through the external terminal FB of the semiconductor integrated circuit 20. The non-inverted-input terminal of the error amplifier 16 receives a reference voltage Vref. The error amplifier 16 generates an error voltage that is an error of the output voltage relative to the reference voltage Vref for provision to the inverted-input terminal of a PWM comparator 17.

The non-inverted-input terminal of the PWM comparator 17 receives a triangular wave of a predetermined frequency from an oscillator 18. The PWM comparator 17 compares the error voltage with the triangular wave to generate a PWM (i.e., pulse width modulation) signal for provision to the switch control unit 15. The switch control unit 15 generates a signal that is an inverse of the PWM signal for provision to the driver circuit 13 through a terminal DRH, and also supplies the PWM signal to the driver circuit 14 through a terminal DRL at the positive transitions of the PWM signal.

Although not shown in the figure, each of the external terminals VIN, BS, and SW of the semiconductor integrated circuit 10 is provided with a high-voltage ESD (electro-static discharge) protection device (having a breakdown voltage of few tens volts, for example) such as a diode having a cathode thereof connected to the external terminals VIN, BS, and SW and an anode thereof connected to the ground.

<Circuit Configuration Diagram of Driver Circuit>

FIG. 5 is a drawing illustrating an example of the circuit configuration of the driver circuit 13. In FIG. 5, the driver circuit 13 includes a level-shift circuit 13a, a latch circuit 13b, and a drive-stage inverter 13c. The level-shift circuit 13a converts an input signal having a high level of 5 V and a low level of 0 V into an output signal having a high level of 17 V and a low level of 12 V when the MOS transistor M1 is in the on state, and performs no conversion when the MOS transistor M1 is in the off state.

The latch circuit 13b latches the output signal of the level-shift circuit 13a. The drive-stage inverter 13c includes a p-channel MOS transistor M11 and an n-channel MOS transistor M12 having a CMOS configuration serving as a first-stage inverter, and includes a p-channel MOS transistor M13 and an n-channel MOS transistor M14 having a CMOS configuration serving as a second-stage inverter.

### RELATED-ART DOCUMENTS

### Patent Document

[Patent Document 1] Japanese Patent Application Publication No. 2002-83872.

### SUMMARY OF THE INVENTION

### Problem to be Solved by Invention

The semiconductor integrated circuit 10 illustrated in FIG. 4 has a problem in that the drive-stage inverter 13c of the driver circuit 13 illustrated in FIG. 5 breaks down when a positive high voltage is applied to the external terminal BS relative to a reference level at the external terminal VIN according to the HBM (human body model) method.

This is because of the following. When a positive high voltage is applied to the external terminal BS relative to a reference level at the external terminal VIN, breakdown occurs between the source and gate of the MOS transistor M13 (or M11) or between the gate and source of the MOS transistor M14 (or M12) before the high-voltage ESD protection device provided at the terminal BS breaks down. As a result, an electric current flows from the external terminal BS into the external terminal VIN through the source and gate of the MOS transistor M13 (or M11), the gate and source of the MOS transistor M14 (or M12), and the body diode of the MOS transistor M1. As this happens, the MOS transistors M13 and M14 (or M11 and M12) are destroyed due to breakdown.

Accordingly, it may be desired to provide a semiconductor integrated circuit that protects circuit elements of the driver circuit from the danger of destruction.

### Means to Solve the Problem

According to one aspect, a DC/DC-converter semiconductor integrated circuit using a bootstrap circuit includes a protection device having a standard breakdown voltage to break down between a first terminal and a second terminal, between which a capacitor of the bootstrap circuit is located, in response to a voltage higher than a maximum voltage applied to the capacitor.

According to one aspect, a semiconductor integrated circuit includes a first external terminal, a second external terminal, a driver circuit to operate with a drive voltage that is a voltage between the first external terminal and the second external terminal, a switching device driven by the driver circuit to intermittently provide electrical conduction between a power supply voltage and the second external terminal, and a protection device situated between the first terminal and the second terminal to break down at a voltage lower than a voltage at which a transistor of the driver circuit breaks down.

### ADVANTAGE OF THE INVENTION

According to at least one embodiment, circuit elements of the driver circuit are protected from the danger of destruction.

### BRIEF DESCRIPTION OF DRAWINGS

FIG. 1 is a block diagram illustrating an embodiment of a semiconductor integrated circuit.

FIG. 2 is a drawing illustrating a circuit configuration of an embodiment of a driver circuit and a protection device.

FIG. 3 is a drawing illustrating a cross-sectional configuration of an embodiment of the protection device.

FIG. 4 is a block diagram illustrating an example of a related-art semiconductor integrated circuit.

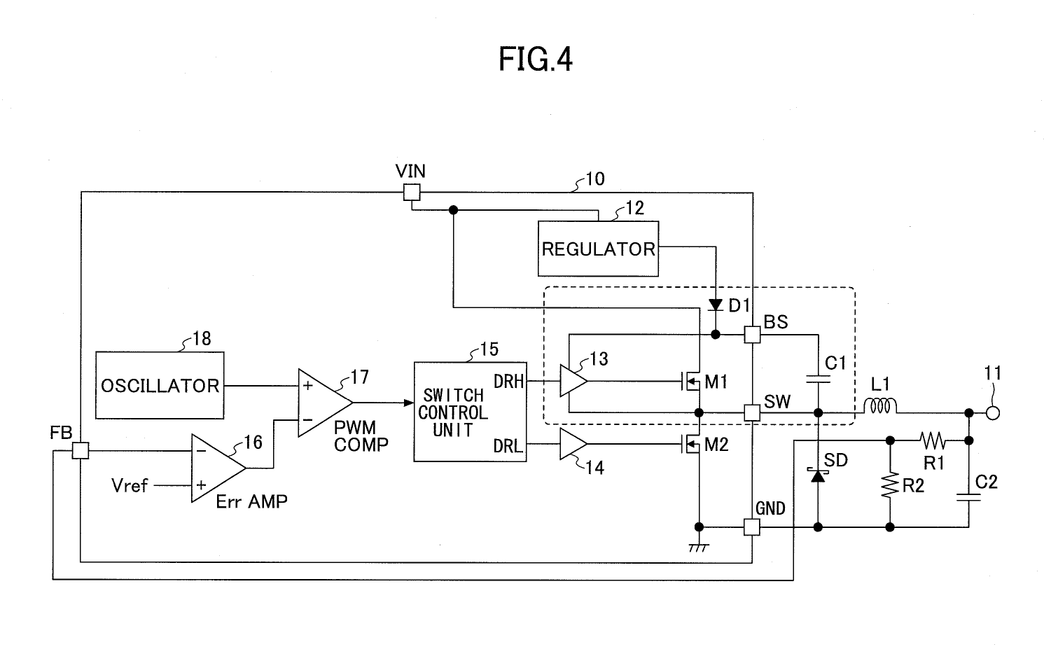

FIG. 5 is a drawing illustrating a circuit configuration of an example of a driver circuit.

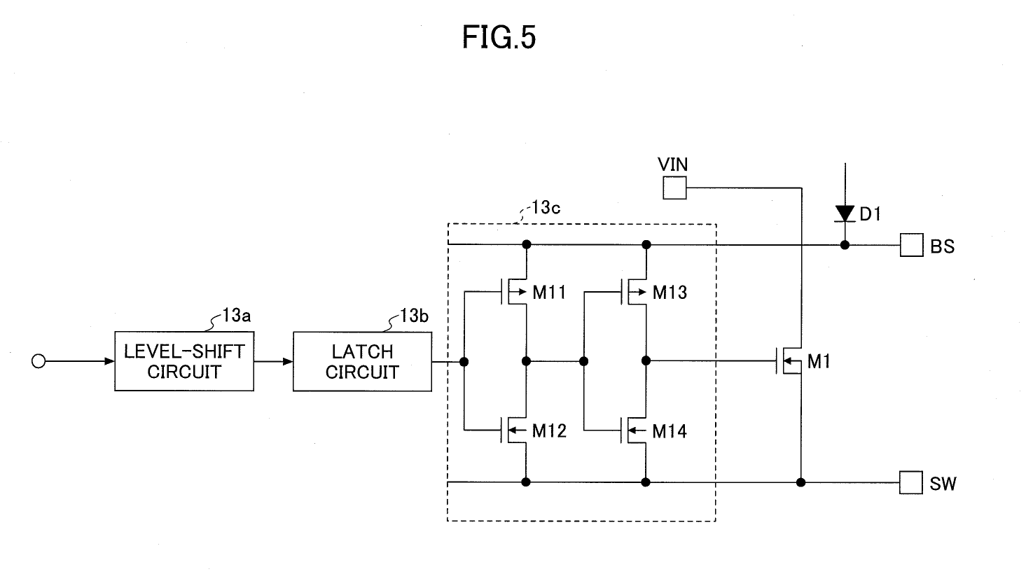

### MODE FOR CARRYING OUT THE INVENTION

In the following, embodiments will be described with reference to the accompanying drawings.

<Block Configuration of Semiconductor Integrated Circuit>

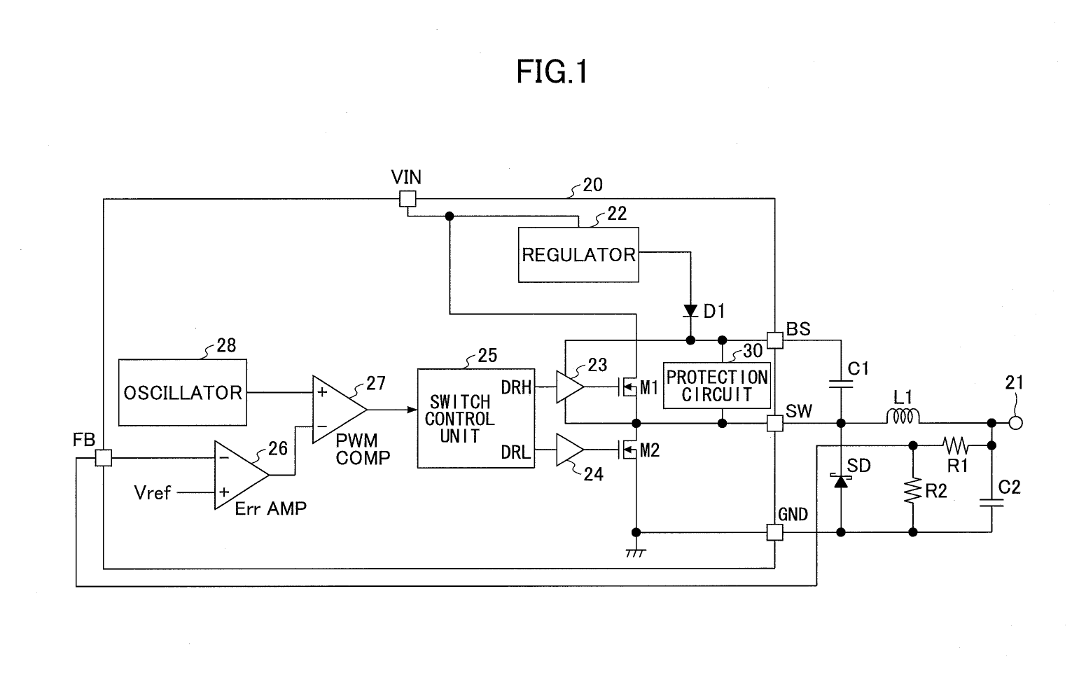

FIG. 1 is a block diagram showing an embodiment of a DC/DC-converter semiconductor integrated circuit 20. In FIG. 1, a capacitor C1 is located between an external terminal BS and an external terminal SW of a semiconductor integrated circuit 20, and a Schottky diode SD is located between the external terminal SW and an external terminal GND. The external terminal SW is connected to an output terminal 21 through an inductor L1.

Series-connected resistors R1 and R2 are located between the output terminal 21 and the external terminal GND. A capacitor C2 also connects therebetween. The connection point between the resistors R1 and R2 is connected to an external terminal FB of the semiconductor integrated circuit 20. A direct-current voltage of 12 V, for example, is applied from an external source to an external terminal VIN of the semiconductor integrated circuit 20.

In the semiconductor integrated circuit 20, further, a protection device 30 having a standard breakdown voltage (e.g., a breakdown voltage of a few volts) is located between the external terminal BS and the external terminal SW. Although not shown in the figure, the external terminal VIN is provided with a high-voltage ESD protection device (having a breakdown voltage of a few tens volts, for example) such as a diode having a cathode thereof connected to the external terminal VIN and an anode thereof connected to the ground.

In the semiconductor integrated circuit 20, a regulator 22 generates a direct-current voltage of 5 V, for example, from the direct-current voltage (e.g., 12 V) supplied through the external terminal VIN for provision to each part of the semiconductor integrated circuit 20, and, also, applies the above-noted 5-V direct-current voltage to the external terminal BS through a diode D1. The external terminal SW is connected to the source of an re-channel MOS transistor M1 and the drain of an n-channel MOS transistor M2 serving as switching devices.

The MOS transistor M1 has a drain thereof connected to the external terminal VIN, and a gate thereof to which a switching signal output from a driver circuit 23 is applied. The driver circuit 23 receives an operating power from the external terminals BS and SW. The MOS transistor M2 has a source thereof connected to the external terminal GND, and a gate thereof to which a switching signal output from a driver circuit 24 is applied.

A switch control unit 25 supplies switching signals having polarities opposite to each other to the driver circuits 23 and 24, respectively, thereby turning on the MOS transistors M1 and M2 alternately. The external terminal SW is set in the ground level when the MOS transistor M1 is in the off state (i.e., M2 in the on state), so that the capacitor C1 is charged with the 5-V voltage, resulting in the external terminal BS being set to 5 V.

The external terminal SW is set to 12 V supplied from the external terminal VIN when the MOS transistor M1 is in the on state (i.e., M2 in the off state), so that the external terminal BS is set to 17 V due to the charged voltage of the capacitor C1. This switching is repeatedly performed to output a predetermined direct-current voltage from the terminal 21 through smoothing by the inductor L1 or the like. In such a configuration in which the voltage at the external terminal SW is switched between HIGH and LOW by the switching devices M1 and M2, the capacitor C1 is provided between the external terminal SW and the external terminal BS. The charged voltage of this capacitor is used to apply a voltage higher than the voltage of the external terminal SW to the external terminal BS, thereby supplying the voltage between the external terminal BS and the external terminal SW to the driver circuit 23 of the HIGH-side switching device M1 as a drive voltage. This makes it possible to fully turn on the HIGH-side switching device M1 that intermittently provides electrical conduction between the external terminal VIN and the external terminal SW. The circuit to provide this high drive voltage is a bootstrap circuit.

During the normal operations, voltage between the external terminals SW and BS does not exceed 5 V. The voltage between the external terminals SW and BS exceeds 5 V at the time of abnormality such as ESD.

The output voltage of the output terminal 21 is divided by the resistors R1 and R2 for provision to the inverted-input terminal of an error amplifier 26 through the external terminal FB of the semiconductor integrated circuit 20. The non-inverted-input terminal of the error amplifier 26 receives a reference voltage Vref. The error amplifier 26 generates an error voltage that is an error of the output voltage relative to the reference voltage Vref for provision to the inverted-input terminal of a PWM comparator 27.

The non-inverted-input terminal of the PWM comparator 27 receives a triangular wave of a predetermined frequency from an oscillator 28. The PWM comparator 27 compares the error voltage with the triangular wave to generate a PWM (i.e., pulse width modulation) signal for provision to the switch control unit 25. The switch control unit 25 generates a signal that is an inverse of the PWM signal for provision to the driver circuit 23 through a terminal DRH, and also supplies the PWM signal to the driver circuit 24 through a terminal DRL at the positive transitions of the PWM signal.

<Circuit Configuration Diagram of Driver Circuit and Protection Device>

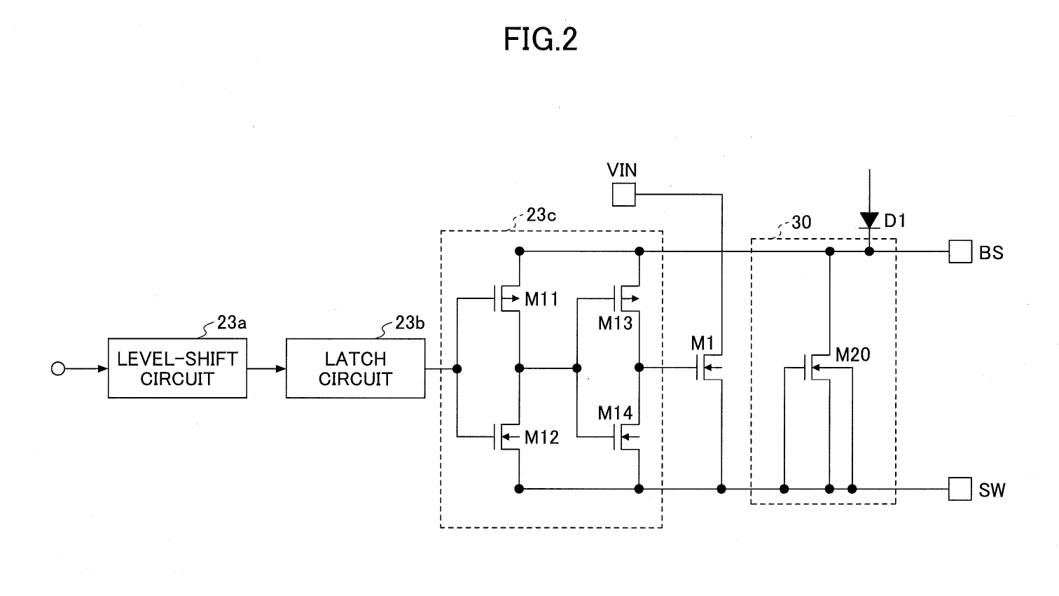

FIG. 2 is a drawing illustrating the circuit configuration of an embodiment of the driver circuit 23 and the protection device 30. In FIG. 2, the driver circuit 23 includes a level-shift circuit 23a, a latch circuit 23b, and a drive-stage inverter 23c.

The level-shift circuit 23a converts an input signal having a high level of 5 V and a low level of 0 V into an output signal having a high level of 17 V and a low level of 12 V when the MOS transistor M1 is in the on state, and performs no conversion when the MOS transistor M1 is in the off state. The latch circuit 23b latches the output signal of the level-shift circuit 23a.

The drive-stage inverter 23c includes a p-channel MOS transistor M11 and an n-channel MOS transistor M12 having a CMOS configuration serving as a first-stage inverter, and includes a p-channel MOS transistor M13 and an n-channel MOS transistor M14 having a CMOS configuration serving as a second-stage inverter. The drains of the MOS transistors M13 and M14 are coupled to the gate of the MOS transistor M1.

The protection device 30 includes an re-channel MOS transistor 20. The MOS transistor 20 has a drain thereof connected to the external terminal BS, and has a gate, source, and back-gate thereof connected to the external terminal SW.

<Cross-sectional Configuration of Protection Device>

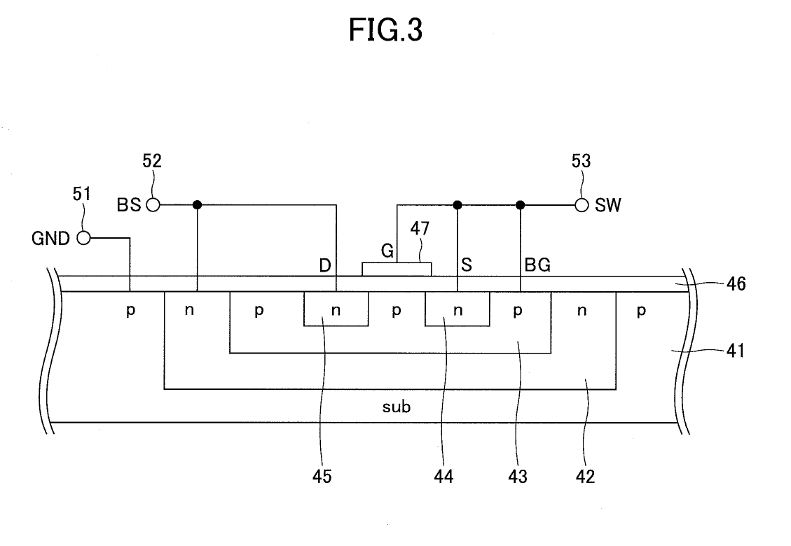

FIG. 3 is a drawing illustrating a cross-sectional configuration of an embodiment of the protection device 30. The protection device 30 has a triple-well structure. In FIG. 3, an n-type well 42 is formed into a predetermined depth from the surface of a p-type semiconductor substrate 41. In the n-type well 42, a p-type well 43 is formed to serve as a back-gate. Further, in the p-type well 43, an n-type region 44 to serve as a source and an n-type region 45 to serve as a drain are formed and spaced apart from each other. An insulating layer 46 is formed on the surface of the semiconductor substrate 41, and a gate electrode 47 is formed on the insulating layer 46.

The p-type semiconductor substrate 41 is connected to the external terminal GND through a terminal 51. The n-type region 45 to serve as a drain and the n-type well 42 are connected to the external terminal BS through a terminal 52. The p-type well 43 to serve as a back-gate, the n-type region 44 to serve as a source, and the gate electrode 47 are connected to the external terminal SW through a terminal 53.

The semiconductor substrate 41 set to the ground level and the p-type well 43 serving as the back-gate are isolated from each other by the n-type well 42. Because of this, a high breakdown voltage (e.g., a few tens volts) is provided between the external terminal GND and the external terminal BS and between the external terminal GND and the external terminal SW. A standard breakdown voltage (e.g., in the range of 6 to 9 V) is provided between the n-type regions 44 and 45 formed in the back-gate p-type well 43, i.e., between the external terminals SW and BS.

When positive high voltage is applied to the external terminal BS relative to a reference level at the external terminal VIN, breakdown occurs between the drain and source of the protection device 30, i.e., between the external terminal SW and the external terminal BS before breakdown occurs between the source and gate of the MOS transistor M13 (or M11) or between the gate and source of the MOS transistor M14 (or M12), thereby protecting the MOS transistors M13 and M14 (or M11 and M12) from destruction. Namely, the protection device 30 breaks down at a lower voltage than the voltage at which the transistors of the drive-stage inverter 23c of the driver circuit 23 break down.

It may be noted that the protection device 30 is configured such that the contacts of the terminals 51 through 53 to the semiconductor substrate 41, the wells 42 and 43, and the n-type regions 44 and 45 have a large size, for example. Because of this, the protection device 30 is not destroyed upon breaking down.

The present application is based on priority application No. 2009-158080 filed on Jul. 2, 2009, with the Japanese Patent Office, the entire contents of which are hereby incorporated by reference.

### DESCRIPTION OF REFERENCE SYMBOLS

20 SEMICONDUCTOR INTEGRATED CIRCUIT

21 OUTPUT TERMINAL

22 REGULATOR

23, 24 DRIVER CIRCUIT

25 SWITCH CONTROL UNIT

26 ERROR AMPLIFIER

27 PWM COMPARATOR

28 OSCILLATOR

30 PROTECTION CIRCUIT

41 SEMICONDUCTOR SUBSTRATE

42 N-TYPE WELL

43 P-TYPE WELL

44, 45 N-TYPE LAYER

46 INSULATING LAYER

47 GATE ELECTRODE

C1, C2 CAPACITOR

D1 DIODE

L1 INDUCTOR

M11-M21 MOS TRANSISTOR

R1, R2 RESISTOR

SD SCHOTTKY DIODE

1. A DC/DC-converter semiconductor integrated circuit using a bootstrap circuit, comprising:
a protection device having a standard breakdown voltage to break down between a first terminal and a second terminal, between which a capacitor of the bootstrap circuit is located, in response to a voltage higher than a maximum voltage applied to the capacitor.

2. The semiconductor integrated circuit as claimed in claim 1, wherein the protection device has such a high breakdown voltage as to break down between the first terminal and a ground terminal and between the second terminal and the ground terminal in response to a voltage higher than the standard voltage.

3. The semiconductor integrated circuit as claimed in claim 2, wherein the protection device includes:
a first layer connected to the first terminal and formed in a semiconductor substrate connected to the ground terminal;
a second layer connected to the second terminal and formed in the first layer;
a drain region connected to the first terminal and formed in the second layer;
a source region connected to the second terminal and formed in the second layer; and
a gate electrode connected to the second terminal and formed in electrical isolation from the semiconductor substrate.

4. The semiconductor integrated circuit as claimed in claim 3, wherein the semiconductor substrate and the second layer are a p type, and the first layer, the drain region, and the source region are an n type.

5. A semiconductor integrated circuit, comprising:
a first external terminal;
a second external terminal;
a driver circuit to operate with a drive voltage that is a voltage between the first external terminal and the second external terminal;
a switching device driven by the driver circuit to intermittently provide electrical conduction between a power supply voltage and the second external terminal; and
a protection device situated between the first terminal and the second terminal to break down at a voltage lower than a voltage at which a transistor of the driver circuit breaks down.
